(19) United States
(12) Patent Application Publication
(10) Pub. No.: US 2004/0107973 A1
(43) Pub. Date: Jun. 10, 2004

(54) Foam injection device and method of filling cavities

(76) Inventor: Charles Gary Atwell, Mechanicsville, VA (US)

Correspondence Address: BURNS, DOANE, SWECKER & MATTHIS, L.L.P., P.O. Box 1404, Alexandria, VA, 22313-1404, US

(21) Appl. No.: 10/314,337

(22) Filed: Dec. 9, 2002

(51) Int. Cl. B31C 13/00; A24D 3/06; A24B 15/00

(52) U.S. Cl. 131/342; 493/39; 131/341; 131/331

(57) ABSTRACT

A system and method for adding material such as foam material to spaced cavities within a cigarette filter. A belt is provided and adapted to be driven synchronously with a moving cigarette filter rod. A plurality of injection needles protrude from the belt at spaced intervals, with the spacing between the needles coinciding with a spacing between the cavities within a cigarette filter rod. A chamber containing an expandable foam material is in fluid communication with one or more of the injection needles at one or more positions along a path traveled by the injection needles.

### FIELD OF THE INVENTION

The present invention relates to systems and methods for filling spaced cavities in a cigarette filter.

### BACKGROUND OF THE INVENTION

Certain articles of manufacture such as charcoal cigarette filters, require repetitive placement of precisely metered charges of particulate matter at some location along the production-line procession of the articles. During high speed mass production of such articles it is difficult to achieve consistent accurate filling of the desired cavities with the granular particles. In the case of filling cigarette filter cavities with charcoal, it is desirable to avoid excessive pulverization and scattering of the particulate material, while achieving as close to 100 percent fill of the cavities as possible.

U.S. Pat. No. 5,875,824, which is incorporated by reference herein in its entirety, discloses a method and apparatus for delivering predetermined amounts of material, wherein a metering wheel receives discrete amounts of material from a supply chute, with the discrete amounts of material being transferred from the metering wheel to a transfer wheel, and from the transfer wheel into spaces along a filter rod. As a result of the transfer of particles from one wheel to another, the pockets for receiving the particulate material in the transfer wheel must be larger than the pockets in the metering wheel. This arrangement makes it difficult to achieve near 100 percent fill of the cavities in the article receiving particulate material from the transfer wheel.

According to the '824 patent, granular particles of charcoal are drawn from a chute in communication with a reservoir into pockets on a rotating metering wheel. The rim of the metering wheel includes a plurality of equally spaced-apart pockets, each of which is defined by a radially directed, conical bore and a discrete screen at the base of the conical bore. The conical bore is convergent in the radially inward direction. A radially directed channel within the rim of the metering wheel communicates a backside of the screen with the interior of the metering wheel. A vacuum can be communicated from a stationary vacuum plenum in the interior of the metering wheel through the radial channel and screen such that any granular particles of charcoal that are adjacent the pocket in the metering wheel will be drawn into the conical bore of the pocket until it is filled.

Charcoal cigarette filters preferably have cavities that are completely filled with particles or granules, with the particles being compacted to a desired density or firmness. Several methods exist for adding particles to empty cavities in a filter rod for a cigarette. In a cigarette filter rod, for example, cavities to be filled with particles can be spaced between other filter components. One method for filling the cavities in a cigarette filter rod with particles includes showering the entire filter rod with the particles to allow the particles to fill the spaced cavities. Another method of filling the cavities with particles includes moving a filter rod with spaced cavities underneath a filling device adapted to hold granular filter material, and introducing the granular filter material into each of the spaced cavities. Yet another method of filling the cavities with particles uses a pocketed vacuum wheel. The pocketed wheel is driven in synchronization with the filter rod and has internal vacuum which pulls particles into the pockets. As each pocket reaches a corresponding filter rod cavity, the particles are blown from the wheel pocket into the filter rod cavity. With the methods described above, the particles fill the cavities loosely and can result in cavities that are not completely filled, and therefore may allow air bypass. The lack of consistency of fill in the cavities may also present quality control problems.

Activated carbon in substantially open-cell, macroporous foam form has been developed for use in a filter for gas such as cigarette smoke, as disclosed in U.S. Pat. No. 3,960,770, which is incorporated herein by reference. The '770 patent does not disclose or suggest the use of such carbonaceous foams with filter media in the form of granules or particles.

In commonly assigned U.S. patent application Ser. No. 09/931,241, filed Aug. 17, 2001, methods and apparatus are disclosed for firmly packing particles or granules in spaced cavities along an article being moved along a manufacturing line. One or more packing mechanisms can be provided downstream of an initial particle filling station in the direction of movement of an article having cavities to be filled with particles or granules. In an embodiment wherein the article with cavities is a combined cigarette filter rod, examples of packing mechanisms for firmly packing the particles in spaced cavities along the filter rod can include a lugged packing wheel, a smooth packing wheel, and a lugged packing belt.

In the case of a lugged packing wheel or a lugged packing belt, or other device having protruding portions that pack only the particles in the spaced cavities, the lugs or protrusions are spaced at a distance that corresponds to the distance between cavities in the article with particles that need to be packed. The lugs are also moved through rotation of the lugged packing wheel or translation of the lugged packing belt at a speed that is synchronized with the speed of movement of the article having cavities to be packed. The synchronization of movement of the packing instrument with movement of the article having cavities ensures that even packing of the particles or granules in the cavities occurs while avoiding damage to the article.

In the case of a combined filter rod or other article having cavities to be filled with particles, side rails can be provided to conform to at least two sides of the article, thereby preventing undesired deformation of the article during the packing process. The side rails in combination with a support rail underneath the article prevent deformation of the article during the packing process while also allowing free movement of the article along the rail support system. An embodiment of the invention disclosed in commonly assigned U.S. patent application Ser. No. 09/931,241, filed Aug. 17, 2001, can also include the application of vacuum to the support rail. In the case of a combined cigarette filter rod, the porous paper that forms the wrapper of the filter rod allows the vacuum to pull particles into the spaced cavities, thereby helping the compacting process. Loose particles may spill out of the cavities in a round or curved surface as fill approaches 100%, even with vacuum being applied, which can cause the particles to scatter down the surface of the internal components that form the cavity. In additional embodiments, vibration can also be applied to the filter rod or rod support rail to allow the particles to pack tighter as they are being compacted.

A problem that can occur when cavities of a cigarette filter are not filled 100 percent by a desired filter media is that partially filled cavities allow bypasses for the air stream. Bypasses for the air stream affect the ability of the filter to completely remove targeted constituents as well as affecting the resistance-to-draw for the cigarette.

### SUMMARY OF THE INVENTION

In view of the above-discussed difficulties with conventional systems for filling cavities in a cigarette filter, the invention provides a system and method for adding material to spaced cavities in a cigarette filter, where the system includes a continuous belt, the belt being adapted to be driven synchronously with a moving cigarette filter, a plurality of injection needles protruding from the belt at spaced intervals, the spacing between the needles coinciding with a spacing between the spaced cavities in the cigarette filter, and a chamber containing the material that is to be added to the spaced cavities, the chamber being in fluid communication with one or more of the injection needles at one or more positions along a path traveled by the injection needles. The continuous belt extends around one or more pulleys or rollers that guide and/or drive the belt and position the belt relative to the moving cigarette filter. The belt can also extend around retractable guides for positioning the belt away from the moving cigarette filter such that the injection needles do not enter the spaced cavities in the filter, and moving the belt adjacent the moving cigarette filter such that the injection needles do enter the spaced cavities. A timing mechanism drives the belt such that the injection needles enter corresponding ones of the spaced cavities and the material from the chamber is injected through the needles into the spaced cavities as the cigarette filter moves past the system. The amount of material that is injected through the needles into the spaced cavities can be controlled such that the amount of material injected can vary depending on whether the sealed cavities in the cigarette filter are already partially filled with a material or are completely empty. Instead of a continuous belt, a wheel or drum, or series of wheels or drums could be used to fill alternate cavities, or every third cavity, etc. The wheels or drums could have the needles or foam injection devices either fixed or cam actuated at the appropriate spacing to match up with rod speed and cavity spacing.

The material that is injected through the needles into the cavities is preferably an expandable foam material. The foam material is made from a desired filtration or flavor media and is permeable to air flow. An example of a foam material that can be used in the method according to an embodiment of the invention is an activated carbon in substantially open-cell, macroporous foam form, such as that disclosed in U.S. Pat. No. 3,960,770, which is incorporated herein by reference. Other examples of foams that could be used in a method according to the invention include thermoplastic high-density polyethylene resin or thermoplastic polypropylene resin containing an expanding agent, and providing the desired micro-structure upon being extruded to form the foam, such as disclosed in U.S. Pat. No. 3,939,849, which is incorporated herein by reference. In the case of a cavity that is already partially filled with granules or particles that help filter the smoke or add flavor to the smoke stream, the injected expandable foam material will expand the granules or particles to eliminate air bypasses. If a cavity is completely empty, the expandable foam material can be injected in a sufficient quantity to completely fill the cavity. The foam injection mechanism is not limited to injection of porous foams such as charcoal porous foam, and is not limited to injecting foam into cavities. Foamed flavors or other filtration materials could be injected. Additionally, the injection does not have to be limited to filling cavities. The foam could be injected into the center of continuous filter rods to form flavor or filter “cells” in the center of components.

In a method of adding material to sealed cavities within a cigarette filter, according to the present invention, a belt is provided having a plurality of injection needles protruding from the belt at spaced intervals, and the belt is moved along a path adjacent a moving cigarette filter, with the movement of the belt being timed such that it is synchronized with the movement of the cigarette filter rod. The synchronization of the belt movement with the movement of the cigarette filter rod ensures that the individual injection needles enter sealed cavities within the cigarette filter and remain within the cavities for a predetermined time before being withdrawn from the cavities, such that the material can be injected through the injection needles into the corresponding sealed cavities.

### BRIEF DESCRIPTION OF THE DRAWINGS

Various features and preferred embodiments of the invention will become apparent upon the consideration of the following detailed description, taken in conjunction with the accompanying drawing, in which each particular reference number refers to particular parts throughout. In the following figure:

FIG. 1 illustrates a system for injecting material into spaced cavities within a cigarette filter rod according to an embodiment of the invention.

### DESCRIPTION OF THE PREFERRED EMBODIMENTS

The invention provides a system and method for injecting a material, such as an expandable foam material, into cavities or spaces within a cigarette filter rod. The cigarette filter rod can be assembled from a number of filter components within a filter combiner machine such that the cigarette filter rod includes alternating cavities or spaces that can be filled with granules or particles, and segments of filter material, such as cellulose acetate tow material. The alternating cavities or spaces that are at least partially filled with the granules or particles and the segments of filter material are enveloped by a paper wrapper to form the cigarette filter rod. A continuous cigarette filter rod formed from the alternating cavities or spaces filled with granules or particles and the filter segments is moved past the system according to the present invention such that the injection needles mounted on the belt can be inserted into each of the cavities through the filter paper, and an expandable foam material can be injected through the needles into the corresponding cavities. The foam injection device could be used to inject desired amounts of expanding foam at desired intervals along a cigarette tobacco rod to help control burn rate, burn temperature or add flavor to the smoke.

The system and method according to the invention can provide sealed cavities within a cigarette filter rod to minimize or eliminate air bypasses.

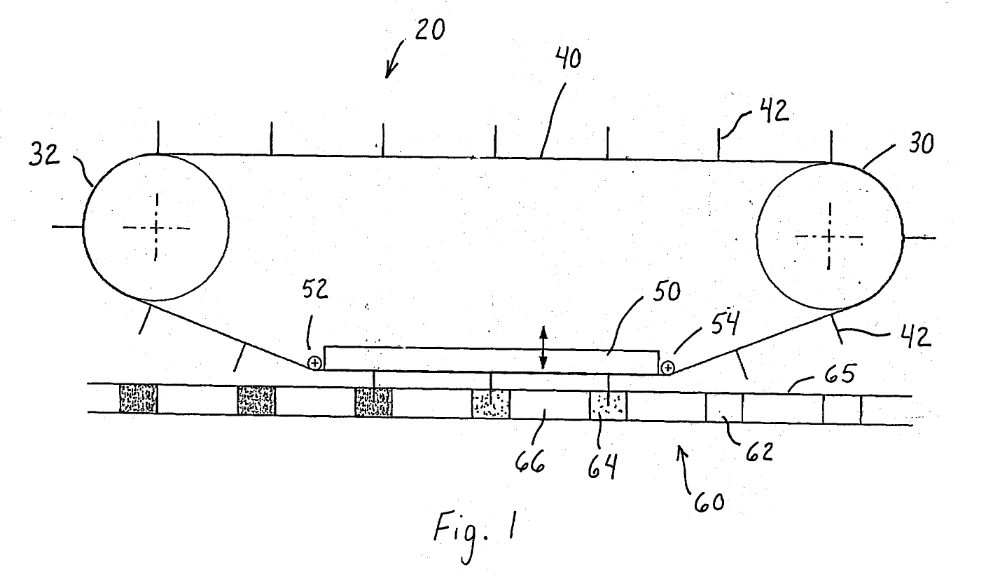

As shown in FIG. 1, a preferred embodiment of the invention provides a belt 40 that extends around drive pulleys 30, 32, and is provided with a plurality of injection needles 42 that extend outwardly from the belt 40. As shown in FIG. 1, the belt 40 is a continuous belt that also extends around guide rods 52, 54 and past a chamber 50 that can be filled with a material to be injected into the cavities of the cigarette filter. As the belt 40 is driven past the chamber 50, each of the injection needles 42 on the portion of the belt 40 passing the chamber 50 is placed in fluid communication with the chamber 50 such that the material can be provided from chamber 50 through the corresponding needles 42 and into corresponding cavities 64 within the cigarette filter rod 60.

The driving pulleys 30, 32 are driven in synchronization with the movement of cigarette filter rod 60 such that each of the injection needles 42 will enter a corresponding cavity 64 as the cavity passes by the chamber 50, and then will be withdrawn from the cavity before passing over the next drive pulley. The guide rods 52, 54 along with the chamber 50 can be moved in the direction of the double-headed arrow shown in FIG. 1 such that the belt is moved toward or away from the traveling cigarette filter rod.

During machine startup, the guide rods 52, 54 and the chamber 50 are moved to a position away from the cigarette filter rod such that the injection needles 42 will not enter corresponding cavities within the cigarette filter rod. After the movement of the belt 40 is synchronized with the movement of the cigarette filter rod 60, guide rods 52, 54 and chamber 50 can then be moved towards the moving cigarette filter rod 60 such that the needles 42 will enter corresponding cavities 64.

An expandable foam material made from the desired filtration or flavor media and being permeable to air flow is injected under pressure from the chamber 50 through needles 42 into corresponding cavities 64. The amount of material injected through the needles into the cavities can be controlled depending on whether the cavities are empty or are partially filled with filter material such as granules or particles. When injecting the expandable foam material into an open cavity, the amount of foam added to the cavity is preferably sufficient to fill the cavity 100 percent. When injecting the foam into a cavity that already has been at least partially filled with granules or particles of a filter media, a smaller amount of the expandable foam material is injected such that it will expand the granules or particles to minimize air bypasses within the cavities.

A timing mechanism, such as a mechanical gear and cam arrangement, ensures that each of the injection needles 42 on the belt 40 will enter a corresponding cavity 64 within the cigarette filter rod 60, and will remain within the cavity for a sufficient amount of time as the belt 40 and the cigarette filter rod 60 move in synchronization to allow for the injection of a desired amount of material into the cavity to eliminate air bypasses. The timed movement of the belt and the cigarette filter rod then ensures that each injection needle 42 is withdrawn from an associated cavity after the injection of material has stopped. If desired, a cleaning cycle can also be added to clean each of the injection needles after it is withdrawn from an associated cavity and before it is once again inserted into another cavity. The cleaning cycle could occur as the needles travel on the return leg of the continuous belt, at the top of FIG. 1. The system and method according to the invention thus can provide a way in which the sealed filter cavities within a cigarette filter rod can be filled with either a permeable foamed filter or flavor material such that all air bypasses are eliminated from within the cavities.

While this invention has been described in conjunction with the exemplary embodiments outlined above, it is evident that many alternatives, modifications and variations will be apparent to those skilled in the art. Accordingly, the exemplary embodiments of the invention as well as alternative embodiments may be made without departing from the spirit and scope of the invention as set forth in the attached claims.

What is claimed is:

1. A system for adding material to spaced-apart cavities along a cigarette filter rod during production thereof, comprising:
a belt, the belt adapted to be driven synchronously with the cigarette filter rod;
a plurality of injection needles protruding from the belt at spaced intervals, the spacing between the needles coinciding with a spacing of the cavities, the injection needles being inserted into the cavities during movement of the belt; and
a chamber containing the material to be added to the cavities, the chamber being in fluid communication with the injection needles inserted into the cavities.

2. The system according to claim 1, wherein:
the belt extends around one or more pulleys that drive the belt and position the belt relative to the moving cigarette filter rod.

3. The system according to claim 2, wherein:
the belt extends around retractable guides adapted to position the belt away from the moving cigarette filter rod such that the injection needles do not enter the cavities or adjacent the moving cigarette filter rod such that the injection needles enter the cavities.

4. The system according to claim 1, further including:
a controller that drives the belt such that the injection needles enter the cavities and the material from the chamber is injected through the needles into the cavities as the cigarette filter rod moves past the system.

5. The system according to claim 4, wherein:
the belt extends around one or more pulleys that drive the belt and position the belt relative to the moving cigarette filter rod.

6. The system according to claim 5, wherein:
the belt extends around retractable guides adapted to position the belt away from the moving cigarette filter rod such that the injection needles do not enter the cavities or adjacent the moving cigarette filter rod such that the injection needles enter the cavities for injection of the material from the chamber.

7. The system according to claim 6, wherein:
the controlled is adapted to select the amount of the material that is injected through the needles into the cavities.

8. The system according to claim 4, wherein the controller drives said belt along a path such that the needles are withdrawn from corresponding spaced cavities after said material has been injected into the corresponding spaced cavities.

9. The system according to claim 8, wherein the chamber contains a supply of foam-forming material in fluid communication with the injection needles inserted into the cavities.

10. The system according to claim 9, wherein granules of filter material are present in the spaced-apart cavities.

11. The system according to claim 10, wherein the injection needles penetrate into the granules of filter material, and the foam-forming material expands the granules to fill the spaced-apart cavities.

12. A method of adding material to cavities within a cigarette filter rod, said method comprising:
moving a belt with a plurality of injection needles protruding from the belt at spaced intervals along a path adjacent a moving cigarette filter rod during production thereof;
inserting the injection needles into the cavities; and
injecting the material through the injection needles into the cavities.

13. The method according to claim 12, further including:
supplying the injection needles with the material from a chamber in fluid communication with the needles; and
injecting a predetermined quantity of the material through the injection needles into the cavities.

14. The method according to claim 13, further comprising sequentially withdrawing the injection needles from the cavities after the predetermined quantity of material has been injected into the cavities.

15. The method according to claim 14, further including:
sequentially subjecting the injection needles to a cleaning process after injection of the material into the cavities.

16. The method according to claim 12, further including moving the belt from said path adjacent the moving cigarette filter rod to a path removed from the moving cigarette filter rod by a distance sufficient to prevent the injection needles from entering the spaced cavities.

17. The method according to claim 16, wherein the step of moving the belt to a path removed from the cigarette filter rod is performed during a startup period.

18. A cigarette filter rod comprising:
an outer wrapper;
a plurality of spaced filter elements made from a fibrous material, said spaced filter elements being supported relative to each other by said outer wrapper; and
a plurality of cavities between said spaced filter elements, said cavities being substantially completely filled by granular material and an expanded foam material.

19. The cigarette filter rod according to claim 18, wherein said spaced filter elements are made from cellulose acetate material and said granular material comprises carbon particles.

20. The cigarette filter rod according to claim 19, wherein said expanded foam material is a carbonaceous polymer.
